(19) United States
(12) Patent Application Publication
(10) Pub. No.: US 2012/0071075 A1
(43) Pub. Date: Mar. 22, 2012

(54) AIR GUIDING DEVICE FOR GUIDING RADIATOR OUTLET AIR FOR A RADIATOR UNIT

(75) Inventor: Thomas Wolf, Riedstadt (DE)

(73) Assignee: DR. ING. H.C.F. PORSCHE AKTIENGESELLSCHAFT, Stuttgart (DE)

(21) Appl. No.: 13/211,547

(22) Filed: Aug. 17, 2011

(30) Foreign Application Priority Data
Sep. 17, 2010 (DE) 10 2010 037 615.9

(51) Int. Cl. B60H 1/24

(52) U.S. Cl. 454/162

(57) ABSTRACT

Air guiding devices are provided in the front end of a vehicle in proximity to the front wheels. Each air guiding device has a laterally arranged air guiding duct with an air inlet opening for guiding radiator fresh air to a radiator and an outlet opening downstream behind the radiator unit for supplying the radiator outlet air to a wheel house. A closure element is arranged in the air outlet opening of the air guiding duct. The closure element is arranged transversely in the vehicle and has adjustable flaps. A separate flow duct is oriented in the longitudinal direction of the vehicle. The separate flow duct has an air entry opening arranged in the transverse plane of the closure element and an air exit opening directed toward a brake disk of a braking system in the front wheel of the vehicle.

### CROSS REFERENCE TO RELATED APPLICATION

This application claims priority under 35 USC 119 to German Patent Appl. No. 10 2010 037 615.9 filed on Sep. 17, 2010, the entire disclosure of which is incorporated herein by reference.

### BACKGROUND OF THE INVENTION

1. Field of the Invention

The invention relates to an air guiding device for guiding radiator outlet air.

2. Description of the Related Art

DE 37 11 682 A1 discloses an air guiding device for cooling air for a vehicle brake, in which a fresh air flow that has entered at an inflow cross section of a guiding duct can be supplied to an associated braking device and to a forced ventilation heat exchanger. The cooling air supply to the braking device is formed substantially by the outlet air flow of the heat exchanger.

It is the object of the invention to provide an air guiding device for guiding cooling air in a front end part of a motor vehicle, via which an outlet air flow of the radiator can be used at the same time to cool a brake disk of a vehicle wheel brake.

### SUMMARY OF THE INVENTION

The invention relates to an air guiding device where a radiator unit is acted upon with fresh air via and a brake disk of a wheel brake for the front wheels that can be cooled via the radiator outlet air. More particularly, a closure element is arranged in an air outlet opening of the guiding duct. The closure element is provided transversely in the vehicle and has adjustable flaps. The closure element is adjoined in a common transverse plane by an air inlet opening of a flow duct. The air exit opening of the flow duct is directed toward the brake disk in the front wheel of the vehicle. The adjustable flaps of the closure element can be pivoted to an open position and a closed position. In the open position, radiator outlet air is supplied to the brake disk of the wheel brake and through the radiator. In the closed position, all of the radiator outlet air is supplied to the brake disk. Thus, in the open position of the flaps, the radiator unit and the brake disk are supplied with cooling air. In the closure position of the flaps, all of the radiator outlet air is supplied to the brake disk, to bring about particularly efficient cooling. Furthermore, the aerodynamic properties of the motor vehicle are improved. The reduced cooling air flow reduces the lifting effect of the front axle and the air drag.

The flaps can be kept in the closure position, for example during constant driving to improve the aerodynamic properties (drag) and to reduce the fuel consumption.

A plurality of adjustable flaps of the closure element may be arranged next to one another in the transverse plane. The flaps are activated to be closed fully or partially depending on a sensor signal indicating the strength and duration of a braking action or the temperature of the brake disk. The adjustable flaps are in the open position in the normal driving mode without significant braking actions to ensure a sufficient throughput of cooling air through the radiator to cool the engine. In this case, most of the radiator outlet air is guided into the wheel house and to the outside and a smaller portion of the radiator outlet air is guided by the flow duct directly to the brake disk. However, this supply of air is sufficient to ensure cooling of the brake disk during normal braking actions.

Alternatively, the flaps of the closure element can be closed partially or completely depending on braking parameters, such as the strength and duration of the braking action or the temperature of the brake disk. In this case, all of the radiator outlet air can be guided to the brake disks. The flaps are opened whenever the brake disk has been cooled or the vehicle is accelerated again since, in contrast to acceleration, during deceleration of the vehicle only little engine cooling is required, but good cooling of the brakes is required. Hence, the flaps then are in a closed position.

The air outlet opening of the guiding duct preferably is adjoins the closure element in the transverse plane and has an air entry opening intended for free entry of air into the wheel house. The air entry opening is bounded by a wheel house wall on which an angularly bent air deflecting blade for guiding the radiator outlet air is provided at a distance from the air entry opening. The radiator outlet air can freely enter the wheel house via the air entry opening placed in the transverse plane of the closure element and can be guided in a specific manner by the deflecting blade in the direction of the wheel brake or the brake disk. The flaps of the closure element can be opened, closed or partially closed in accordance with prevailing conditions regarding a sufficient throughput of air through the radiator or the cooling of the brake disks or of the wheel brakes.

The individual flaps of the closure element can be pivoted at different angles or identical angles in the open position so that the radiator outlet air can be guided obliquely with respect to the vehicle outside or directly to the vehicle wheel or into the interior of the wheel house or to the flow duct. This adjustment of the flaps either jointly in an identical angle position or in different angle positions enables the radiator outlet air to be guided correspondingly into the wheel house.

An exemplary embodiment of the invention is illustrated in the drawings and is described in more detail below.

### BRIEF DESCRIPTION OF THE DRAWINGS

FIG. 1 shows a view of an air guiding device with a lateral air guiding duct in a front end part of a vehicle, with an inner radiator unit and a closure element, which has adjustable flaps and is intended for the radiator outlet air, in an open position.

FIG. 2 shows the air guiding device according to FIG. 1 in a closed position of the closure element.

FIG. 3 shows the air guiding device with the closure element in an air exit opening for the radiator outlet air in a transverse plane next to the closure element.

### DETAILED DESCRIPTION OF THE PREFERRED EMBODIMENTS

An air guiding device 1 is arranged in a front end part 2 of a vehicle 3 and comprises a lateral air guiding duct 4 with a front inlet opening 5 and a rear air outlet opening 6 with respect to the direction of travel F. A radiator unit 7 is arranged in the air guiding duct 4 and has a radiator 8 and a fan 9 behind the radiator 8. The air outlet opening 6 of the air guiding duct 4 has a closure element 11 extending in a transverse plane x-x of the vehicle 3. The closure element 11 includes adjustable flaps 10.

An air entry opening 12 for a flow duct 14 is provided together with the closure element 11 in the transverse plane x-x. The flow duct 14 extends in the longitudinal direction of the vehicle into the wheel house R and includes an air exit opening 15 that is directed toward a brake disk 16 of a braking system in the front wheel 17 of the vehicle 3.

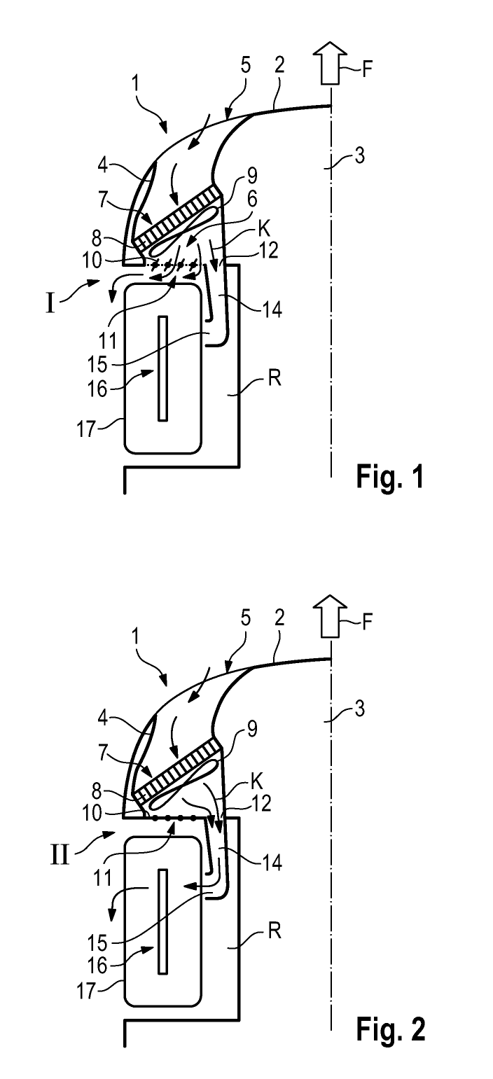

The adjustable flaps 10 of the closure element 11 in the air outlet opening 6 of the air guiding duct 4 can be pivoted into an open position I (FIG. 1) or into a closed position II (FIG. 2) depending on requirements. In the open position I of the flaps 10, the radiator 8 and the wheel brake 16 are supplied with sufficient cooling air. By contrast, in the closed position II of the flaps 10, all of the radiator outlet air K is supplied to the brake disk 16 of the wheel brake.

A plurality of adjustable flaps 10 are arranged next to one another in the transverse plane x-x of the air guiding duct 4. The flaps 10 can be activated so that a sufficient throughput of cooling air through the radiator 8 is ensured for cooling the engine in a normal driving mode without significant braking actions. The flaps 10 of the closure element 11 are open in the driving state so that the outlet air side is deconstricted to the maximum and the radiators 8 can be supplied with sufficient cooling air. On the outlet air side, most of the radiator outlet air is guided into the wheel house R, with a smaller portion being guided through the flow duct 14 to the brake disk 16. However, the supply of air is sufficient to cool the brake disk 16 during normal braking actions.

In contrast to the normal driving mode, during deceleration of the vehicle 3 only relatively low engine cooling is required, but good cooling of the brakes is required. Powerful braking actions are required in this vehicle deceleration case. Hence, a sensor S records parameters of the brake disk and operates the closure element 11 for partially or completely closing the opening into the wheel house 16 to avoid the risk of overheating of the brake disks 16. Therefore most or all of the radiator outlet air is guided to the brakes or the brake disk 16. This state is maintained until the brake disks 16 are sufficiently cooled or the vehicle 3 is accelerated again.

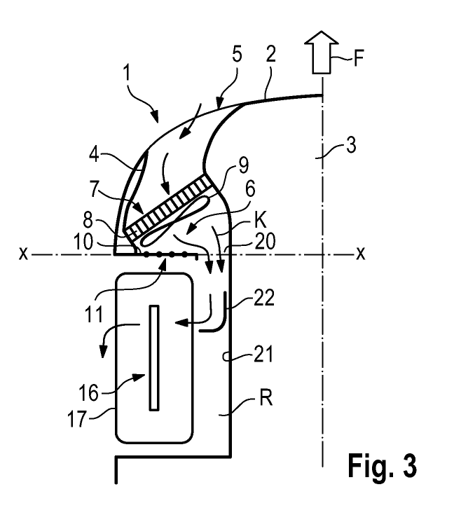

FIG. 3 illustrates a further embodiment where an air entry opening 20 for the radiator outlet air K into the wheel house R to the brake disk 16 is provided in the transverse plane x-x next to the closure element 11 that has the flaps 10. The radiator outlet air K enters directly through the air entry opening 20 in the transverse plane x-x into the wheel house and is guided from the wheel house inner wall 21 by a deflecting blade 22 that is arranged at a distance from the air entry opening 20. The deflecting blade 22 deflects the air flow K at an angle to the brake disk 16.

The individual flaps 10 of the closure element 11 may also be positioned at different or identical angles, this taking place via a corresponding flap actuating means such that the radiator outlet air K can enter the wheel house R in different directions in accordance with the cooling requirements.

What is claimed is:

1. An air guiding device for guiding radiator outlet air for a radiator unit that is arranged in a front end part of a motor vehicle, the air guiding device comprising a lateral air guiding duct with an air inlet opening forward of the radiator unit for guiding radiator fresh air to the radiator unit, the lateral air guiding duct further having an air outlet opening downstream behind the radiator unit and communicating with a wheel house of the motor vehicle for supplying radiator outlet air to the wheel house that accommodates a front wheel of the vehicle, the air outlet opening of the air guiding duct having a closure element arranged transversely in the vehicle and including adjustable flaps, a flow duct having an air entry opening arranged substantially in a common transverse plane with the closure element, the flow duct further having an air exit opening that is directed toward a brake disk of a braking system in the front wheel of the vehicle.

2. The air guiding device of claim 1, wherein the adjustable flaps of the closure element are pivotable between an open position and a closed position, radiator outlet air being supplied to the brake disk of the braking system and through the radiator when the adjustable flaps are in the open position and all of the radiator outlet air being supplied to the brake disk of the wheel brake when the adjustable flaps are in the closed position.

3. The air guiding device of claim 1, wherein the adjustable flaps of the closure element are arranged next to one another in the transverse direction, said flaps being activatable to be fully closed or partially closed depending on a sensed strength and duration of a braking action or the temperature of the brake disk.

4. The air guiding device of claim 1, wherein the air outlet opening of the air guiding duct has an air entry opening adjoining the closure element and arranged in the transverse plane and accommodating a free entry of air into the wheel house, the air entry opening being bounded by a wheel house wall, an angularly bent air deflecting blade being provided on the wheel house wall at a distance from the air entry opening and being configured for guiding radiator outlet air to the brake disk.

5. The air guiding device of claim 1, wherein the individual flaps of the closure element are pivotable at different or identical angles to selected open positions for guiding the radiator outlet air obliquely with respect to at least one of the vehicle outside, the vehicle wheel, the interior of the wheel house and the flow duct.

6. A motor vehicle comprising: a front end, a front wheel house rearward of the front end, a wheel mounted in the front wheel house and a brake disk in proximity to the wheel, an air guiding duct having an air inlet opening forward of the front wheel house, a radiator in the air guiding duct for receiving radiator fresh air from the air inlet opening, the air guiding duct further having an air outlet opening rearward of the radiator and disposed for guiding radiator outlet air to the front wheel house, the air outlet opening of the air guiding duct having a closure element arranged transversely in the vehicle and including adjustable flaps, a flow duct having an air entry opening arranged substantially in a common transverse plane with the closure element, the flow duct further having an air exit opening that is directed toward the brake disk.

7. The motor vehicle of claim 6, wherein the adjustable flaps of the closure element are pivotable between an open position and a closed position, radiator outlet air being supplied to the brake disk of the braking system and through the radiator when the adjustable flaps are in the open position and all of the radiator outlet air being supplied to the brake disk of the wheel brake when the adjustable flaps are in the closed position.

8. The motor vehicle of claim 6, wherein the adjustable flaps of the closure element are arranged next to one another in the transverse direction, said flaps being activatable to be fully closed or partially closed depending on a sensed strength and duration of a braking action or the temperature of the brake disk.

9. The motor vehicle of claim 6, wherein the air outlet opening of the air guiding duct has an air entry opening adjoining the closure element and arranged in the transverse plane and accommodating a free entry of air into the wheel house, the air entry opening being bounded by a wheel house wall, an angularly bent air deflecting blade being provided on the wheel house wall at a distance from the air entry opening and being configured for guiding radiator outlet air to the brake disk.

10. The motor vehicle of claim 6, wherein the individual flaps of the closure element are pivotable at different or identical angles to selected open positions for guiding the radiator outlet air obliquely with respect to at least one of the vehicle outside, the vehicle wheel, the interior of the wheel house and the flow duct.
